(19) United States
(12) Patent Application Publication
(10) Pub. No.: US 2025/0234429 A1
(43) Pub. Date: Jul. 17, 2025

(54) Wire Fixing Structure for Electric Blanket

(71) Applicant: JIANGSU CHENGZHUO HEALTH TECHNOLOGY CO., LTD., Jiangsu Province (CN)

(72) Inventor: Shiqiong Yang, Jiangsu Province (CN)

(73) Assignee: JIANGSU CHENGZHUO HEALTH TECHNOLOGY CO., LTD., Jiangsu Province (CN)

(21) Appl. No.: 18/415,486

(22) Filed: Jan. 17, 2024

(51) Int. Cl. H05B 3/34

(52) U.S. Cl. CPC H05B 3/342

(57) ABSTRACT

An electric blanket is provided with a novel wiring structure, which includes an electric blanket body having resistance wires laid inside and a controller connected to the resistance wire circuit. The electric blanket body includes an upper layer of fabric and a middle layer that has a heating wire quilted to it by a sewing thread in a zig-zag manner. The spacing between adjacent portions of the sewing thread is one to five times the diameter of the resistance wire. The wiring structure of the electric blanket is firm, reliable, and highly safe, and can effectively avoid the problem of local high temperature and subsequent fire danger that might be caused by the resistance wires getting tangled together during long-term use or cleaning.

### BACKGROUND OF THE INVENTION

### 1. Field of the Invention

The utility model relates to electric blankets, and in particular, to an electric blanket with a new wire fixing structure.

### 2. Description of the Prior Art

The electric blanket is mainly composed of an electric blanket body and a controller connected to the electric blanket body. A resistance wire is arranged inside the electric blanket body. After the resistance wire is energized, it generates heat to keep people warm from the cold. In the prior art, the resistance wires in the electric blanket body are threaded into the sewn cavity of an electric blanket body. The resistance wires are basically movable inside the electric blanket. This is especially true for those washable electric blankets. When the electric blanket is rubbed, the resistance wires may get tangled together, which may cause local high temperatures and lead to fire and injury.

### SUMMARY OF THE DISCLOSURE

The technical problem to be solved by this invention is to provide an electric blanket with a new type of wire fixing structure that has strong, reliable wiring and high safety in view of the current situation of the above-mentioned existing technology.

The technical solutions adopted by this invention to solve the above technical problems are:

An electric blanket having a novel wiring structure, including an electric blanket body with a resistance wire laid inside and a controller connected to the resistance wire circuit. The electric blanket body includes an upper layer of fabric, a middle layer of fabric, and a lower layer of fabric stitched together. The resistance wire is directly fixed to the middle layer of fabric by circumferentially stitching a sewing thread in a zig-zag manner, and the spacing of the sewing thread and quilting is one to five times the diameter of the resistance wire.

Compared with the prior art, the resistance wire of the present invention is directly quilted and fixed on the fabric in a zig-zag manner using a sewing thread, and the quilting spacing between adjacent portions of the sewing thread is one to five times the diameter of the resistance wire. Compared with the traditional wiring structure with quilted wiring holes, the wiring structure of the present invention is firmly fixed and does not move. Therefore, the resistance wires can be prevented from getting entangled together during long-term use or cleaning, reducing the risk of causing high temperature that may lead for fires.

### BRIEF DESCRIPTION OF THE DRAWINGS

FIG. 1 is a schematic structural diagram of an electric blanket according to the present invention.

FIG. 2 is a side view of FIG. 1.

FIG. 3 is an exploded perspective view of the electric blanket of FIG. 1.

FIG. 4 is a schematic cross-sectional structural diagram of the resistance wire of the electric blanket of FIG. 1.

FIG. 5 is a schematic top view of the resistance wire of the electric blanket of FIG. 1 fixed on the middle fabric.

FIG. 6 is a schematic structural diagram of the connector male end of the present invention.

### DETAILED DESCRIPTION OF THE PREFERRED EMBODIMENTS

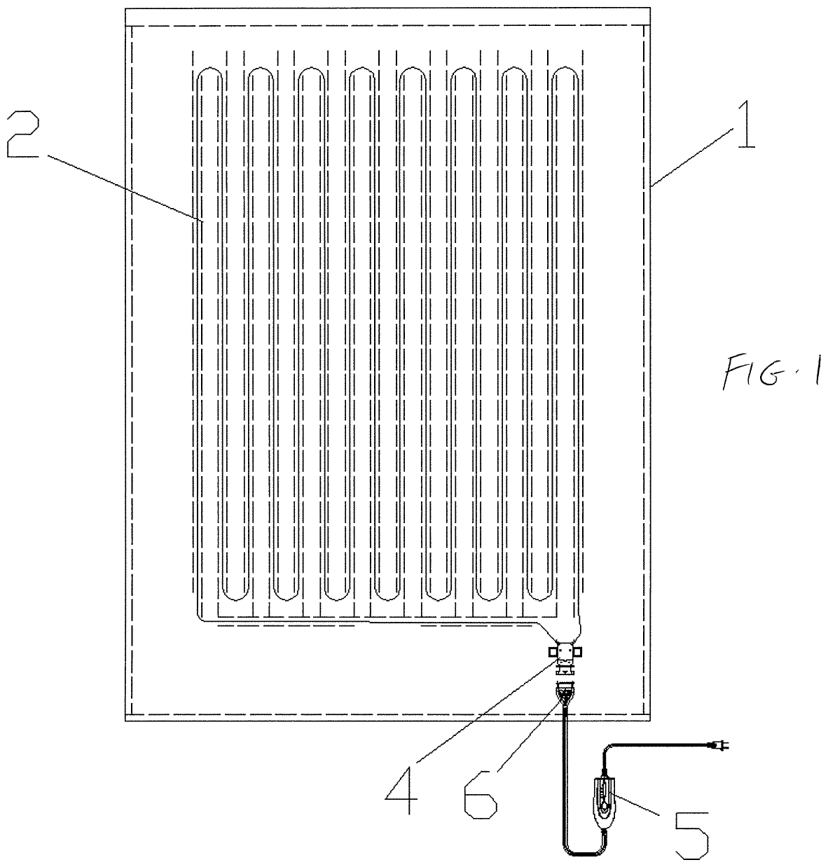

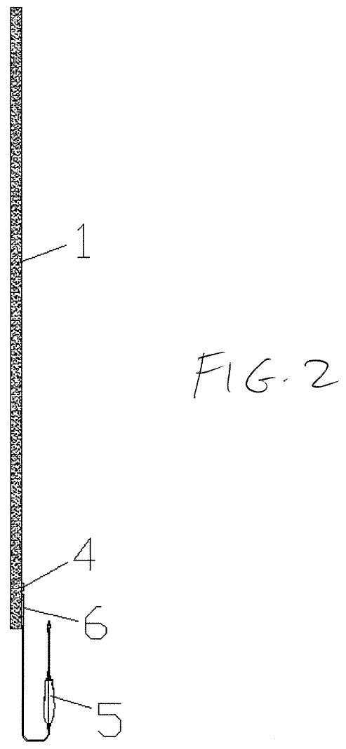

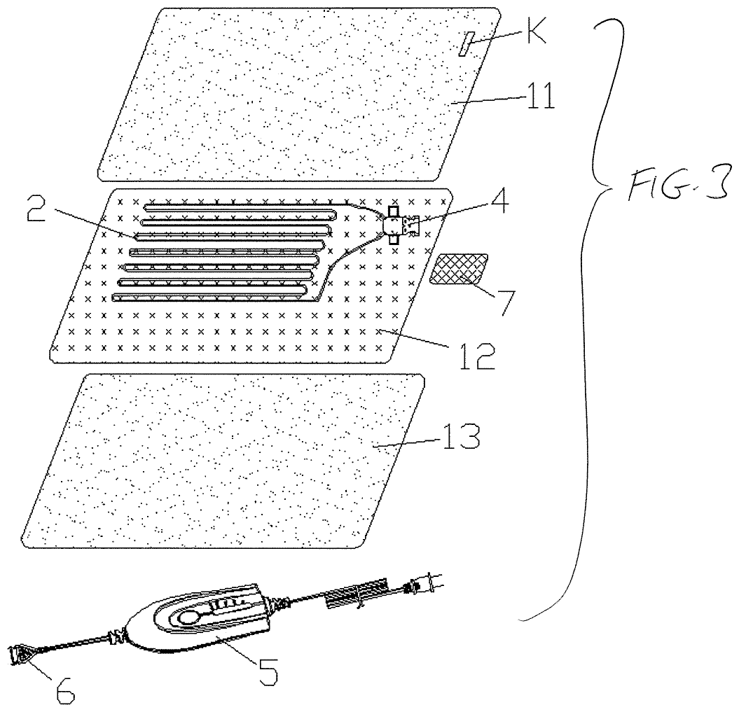

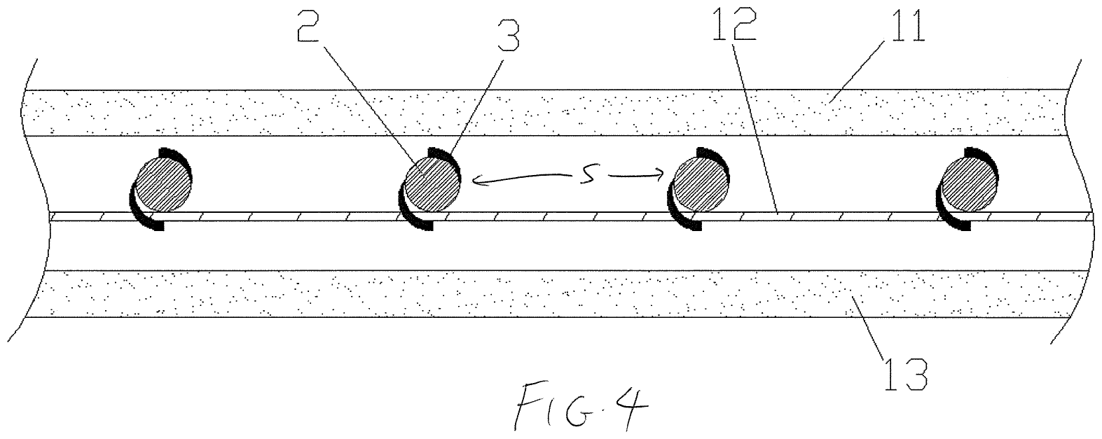

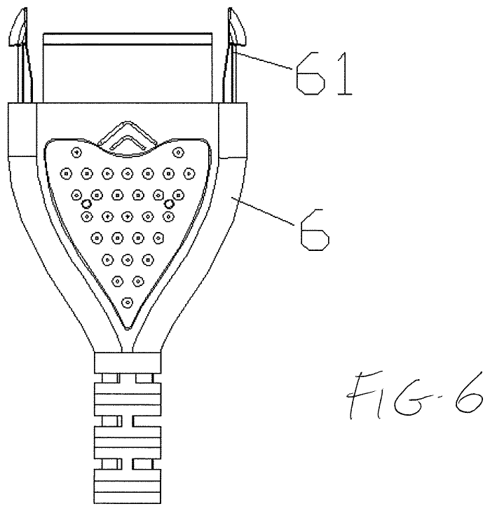

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. FIGS. 1 to 6 illustrate an electric blanket according to the present invention.

The reference numbers are: outlet K, electric blanket body 1, upper fabric 11, middle fabric 12, lower fabric 13, resistance wire 2, sewing thread 3, connector female end 4, controller 5, connector male end 6, anti-attachment hook 61, keyhole cloth 7.

The present invention discloses an electric blanket with a new wiring structure. Traditional electric blankets are quilted with vertical and horizontal wiring channels between two cloth layers, and the resistance wires are arranged in the quilted wiring channels. For electric blankets with this type of structural wiring structure, the resistance wires experience relative movement in the wiring channels. Therefore, when used for a long time or during cleaning, the resistance wires may become tangled together, which may cause local high temperatures that may lead to fires and injuries.

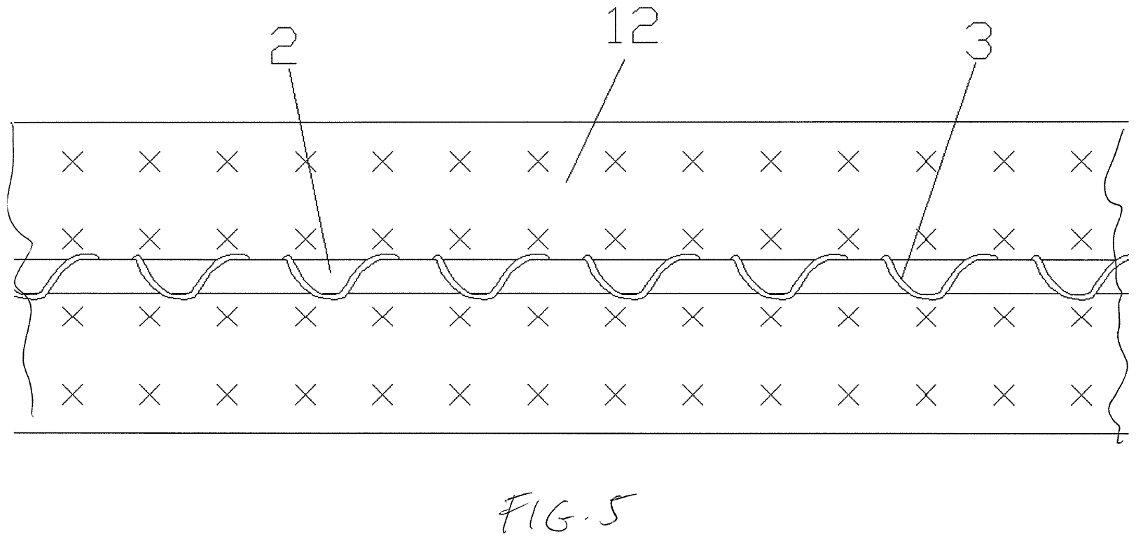

As shown in FIGS. 1-6, the electric blanket of the present invention includes an electric blanket body 1, a resistance wire 2 and a controller 5. The electric blanket body 1 includes three fabric layers, including an upper fabric 11, a middle fabric 12 and a lower fabric 13 from top to bottom. The three fabric layers 11, 12, 13 are quilted to form a complete blanket body. The resistance wire 2 is laid in the electric blanket body 1. Specifically, it is directly fixed to the middle layer fabric 12 by surrounding quilting with sewing threads 3. The threads 3 are sewn in a zig-zag arrangement, which is best shown in FIG. 5. In addition, the spacing S between adjacent portions of the quilting threads 3 is one to five times the diameter of the resistance wire 2.

This wiring structure (i.e., a zig-zag stitch and the prescribed spacing S) can firmly fix the resistance wire 2 on the middle fabric 12 and prevent the resistance wire 2 from moving. After the resistance wire 2 is first fixed on the middle fabric 12, the three cloth layers 11, 12, 13 are then quilted into one unit using traditional methods, thereby further strengthening the fixation of the resistance wire 2. The controller 5 and the resistance wire 2 are part of a pluggable electrical connection with the controller 5 having an outlet plug that can be plugged into a wall outlet, and the controller 5 is used to control the on/off circuit of the resistance wire 2 and regulate the temperature.

The zig-zag stitch and the stitch spacing S are important because the stitch spacing S will affect whether the final wash test can be passed. If the space S is too large, the portions of the resistance wire 2 will be separated after washing, and if the spacing S is too small, the production time for the electric blanket will be too long, resulting in high costs.

In this embodiment, the upper fabric 11 is fixedly installed with a connector female end 4, which is electrically connected to the resistance wire 2. One end of the controller 5 is provided with a connector male end 6 that has a detachable plug-in connector for detachably plugging and unplugging the connector female end 4.

In this embodiment, the connector male end 6 has an anti-detachment hook 61. Correspondingly, the connector female end 4 is designed with a hook groove (not shown) for hooking and cooperating with the anti-detachment hook 61. The anti-detachment hook 61 is an elastic hook, which can be released from the hook groove by pressing, so as to achieve the purpose of quick assembly and disassembly.

In this embodiment, the upper fabric 11 of the present invention is provided with an outlet K for facilitating the extraction of both ends of the resistance wire 2.

In this embodiment, a keyhole cloth 7 for positioning the lead wire is sewn at the outlet K of the present invention. The keyhole cloth 7 can further strengthen the local pulling force of the electric blanket at the connector female end 4, and limit and prevent the resistance wire 2 from being pulled.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An electric blanket, comprising:
an electric blanket body having an upper layer of fabric, a middle layer of fabric, and a lower layer of fabric stitched together in sequence;
a resistance wire fixed on the middle layer of fabric by circumferentially quilting a sewing thread around the resistance wire in a zig-zag manner, with the quilting spacing between adjacent portions of the sewing thread is one to five times the diameter of the resistance wire; and
a controller electrically connected to the resistance wire.

2. The electric blanket of claim 1, wherein a connector female end (4) fixedly installed on the upper fabric and electrically connected to the resistance wire, and the controller has one end which is provided with a connector male end for detachable plug-in connection with the connector female end.

3. The electric blanket of claim 2, wherein the connector male end has an anti-detachment hook, and the connector female end has a hook groove for releasably engaging the anti-detachment hook.

4. The electric blanket of claim 1, wherein the upper fabric is provided with lead-out openings for facilitating the extraction of the resistance wire.

5. The electric blanket of claim 1, wherein the upper fabric has an outlet that is sewn with a keyhole cloth.
